(19) United States
(12) Patent Application Publication
(10) Pub. No.: US 2015/0381799 A1
(43) Pub. Date: Dec. 31, 2015

(54) PORTABLE TELEPHONE WITH INTERFACE FOR EASY FUNCTION START UP BASED ON ENTRY OF KEYS

(71) Applicant: KYOCERA Corporation, Kyoto-shi (JP)

(72) Inventor: Hitomi YAMASAKI, Osaka (JP)

(73) Assignee: KYOCERA Corporation

(21) Appl. No.: 14/849,439

(22) Filed: Sep. 9, 2015

Related U.S. Application Data
(63) Continuation of application No. 12/994,719, filed on Nov. 24, 2010.

(30) Foreign Application Priority Data
May 27, 2008 (JP) 2008-138079

(51) Int. Cl. H04M 1/725

(52) U.S. Cl. CPC H04M 1/72583; H04M 1/7258

(57) ABSTRACT

Upon receiving entry of a dial key on a standby screen (80a) of a mobile phone, a sequence of numerals corresponding to the entry is displayed on a screen (80b), and the mobile phone becomes ready for making a call to a phone number represented by the displayed sequence of numerals. When any dial key is entered six times in succession, a function name “IrDA” is searched for, which relates to letters “ir” identified based on entry of the dial keys of “4GHI”, “4GHI”, “4GHI”, “7PQRS”, “7PQRS”, and “7PQRS”, and then the function name “IrDA” is displayed as an alternative (84) on a screen (80d). At the same time, a sequence of numerals “444777” is displayed as an alternative (85). Upon receiving selection of the alternative (84), an infrared receiving function is executed as shown on a screen (80e). Upon receiving selection of the alternative (85), it becomes ready for making a call to a phone number represented by the sequence of numerals “444777” as shown on a screen (80f). Upon receiving selection of an alternative (86), a selected word “iron” is output into a display area of a mail body of a mail as shown on a screen (80g).

### CROSS REFERENCE TO RELATED APPLICATIONS

The present application is a continuation of U.S. application Ser. No. 12/994,719 filed on Nov. 24, 2010, which claims the benefit of PCT Application No. PCT/JP2009/002343 filed on May 27, 2009, which claims the benefit of Japanese Application No. JP2008-138079 filed on May 27, 2008. The contents of the above applications are each incorporated herein by reference in their entirety.

### TECHNICAL FIELD

The present invention relates to a user interface of a mobile phone.

### BACKGROUND ART

There is a tendency to equip a mobile phone with, in addition to the original call function, many functions such as a mail function, a camera function, a TV function, and a scheduling function.

According to a conventional art, it is possible to assign a standard function such as the mail function and the camera function to a specific operation key so as to call such a standard function with one-touch operation.

### SUMMARY OF INVENTION

### Technical Problem

In this way, there has been adopted a method for easily accessing the standard function. However, regarding a function a user infrequently uses (minor function), there is a tendency to necessitate to perform complicated operations to start up such a minor function.

For example, in order to start up a function, the user sometimes needs to perform operations to trace the hierarchical structure menu multiple times. Also, a user who is unfamiliar with operating a mobile phone might have difficulty of selecting a desired function among many items of a menu.

In view of this, it is conceivable to adopt a method for assigning the minor function to a key as well as the standard function. However, it is difficult to assign all of many functions to the limited number of keys in one-to-one correspondence. Furthermore, from the user's viewpoint, it is troublesome to memorize which function is assigned to which key.

By the way, in general, when a mobile phone in a standby mode receives entry of a phone number via pressing of dial keys, the entered phone number is displayed such that the user can make a call to the displayed phone number. Accordingly, it is also necessary to give consideration to easy startup of the call function originally provided in the mobile phone.

The preset invention was made in view of the above problem, and aims to provide a mobile phone that is capable, when receiving entry of dial keys in a standby mode, of starting up a desired function with a simple operation and giving consideration to making a call.

### Solution to Problem

The present invention provides a mobile phone that includes keys to which numerals and letters are assigned, and when receiving key entry of any of the keys in a standby mode, displays a numeral corresponding to the key entry, the mobile phone comprising: a control unit operable, when a predetermined condition is satisfied by a sequence of numerals corresponding to key entry received in the standby mode, to display a function name including one or more letters corresponding to the key entry; and a startup unit operable to start up a function indicated by the displayed function name.

### Advantageous Effects of Invention

According to the mobile phone relating to the present invention, a function name including one or more letters corresponding to key entry is displayed, a function indicated by the function name is started up. This allows a user to easily start up a function.

### BRIEF DESCRIPTION OF DRAWINGS

FIG. 1 shows an external appearance of a mobile phone 2 relating to an Embodiment 1.

FIG. 2 is a functional block of the mobile phone 2.

FIG. 3 shows an example of a data structure of a function dictionary 56.

FIG. 4 is a flow chart showing operations of the mobile phone 2.

FIG. 5 is a flow chart showing operations of the mobile phone 2.

FIG. 6A to FIG. 6G show switching screens 80a to 80g on a display, respectively.

FIG. 7 is a functional block of a mobile phone 2 relating to an Embodiment 2.

FIG. 8 shows an example of a data structure of an address book 60.

FIG. 9 shows an example of a data structure of an address dictionary 58.

FIG. 10 is a flow chart showing operations of the mobile phone 2.

FIG. 11A to FIG. 11G show switching screens 90a to 90g on a display, respectively.

FIG. 12 shows a data structure of a number table 62.

### DESCRIPTION OF EMBODIMENTS

### Embodiment 1

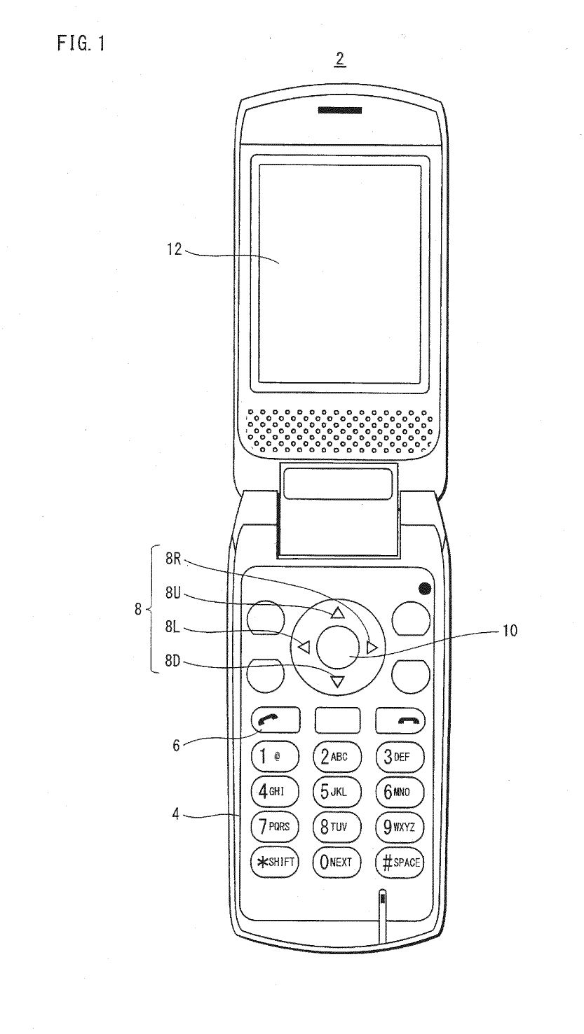

The following describes an Embodiment 1 with reference to the drawings. <Structure> FIG. 1 shows an external appearance of a mobile phone 2.

The mobile phone 2 includes a dial key group 4, a call key 6, a cursor key group 8, a center key 10, and a display 12.

The dial key group 4 is composed of 12 keys beginning with a “1@” key on the top left and ending with a “#SPACE” key on the bottom right. Each of the keys has a number and a letter sealed on a keycap thereof.

The mobile phone 2 has, as a Text Entry mode, a number mode (Numbers Only mode) and a letter mode (Alpha mode).

The mobile phone 2 in the number mode (Numbers Only mode) receives entry of a key that has been pressed, as entry of a numeral corresponding to the pressed key. For example, when a “3DEF”. key is pressed three times in succession, the entry of the key is received as entry of a sequence of numerals “333”.

Compared with this, the mobile phone 2 in the letter mode (Alpha mode) switches a letter to be displayed each time the same key is pressed. For example, when the same “3DEF” key is repeatedly pressed, the mobile phone 2 in the letter mode (Alpha mode) displays one letter by repeatedly switching among letters “d”, “e”, and “f” in this order˜The letter mode is used in a function for editing texts such as a mail function.

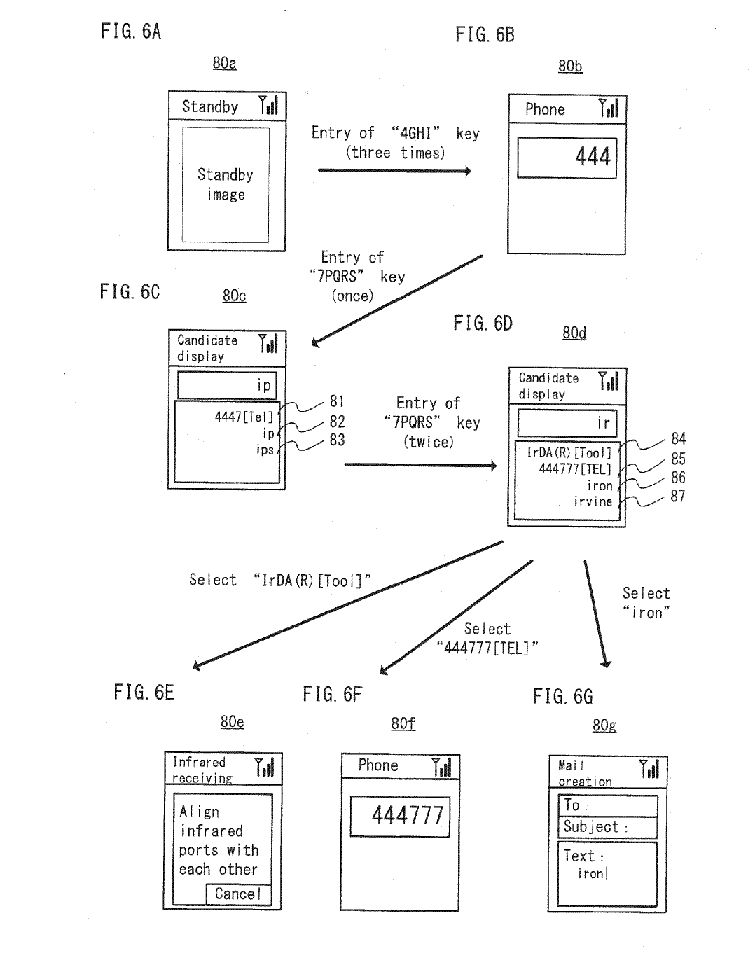

According to the present embodiment, when the mobile phone 2 in the standby mode receives entry of a key, until a predetermined condition is satisfied, the mobile phone 2 in the standby mode performs operations that are the same as in the number mode. When the predetermined condition is satisfied, the mobile phone 2 in the standby mode displays a numeral, a letter, and a function relating to the letter on the same screen (see FIG. 6).

An “*SHIFT’ key is used for switching between an upper case letter and a lower case letter.

The call key 6 is used for making a call.

The cursor key group 8 is used for shifting a cursor for selecting an entry position and an alternative, and is composed of an upper key 8U, a lower key 8D, a left key 8L, and a right key 8R.

The center key 10 is located on the center of the circular cursor key group 8, and is used for determining a selected alternative, for example.

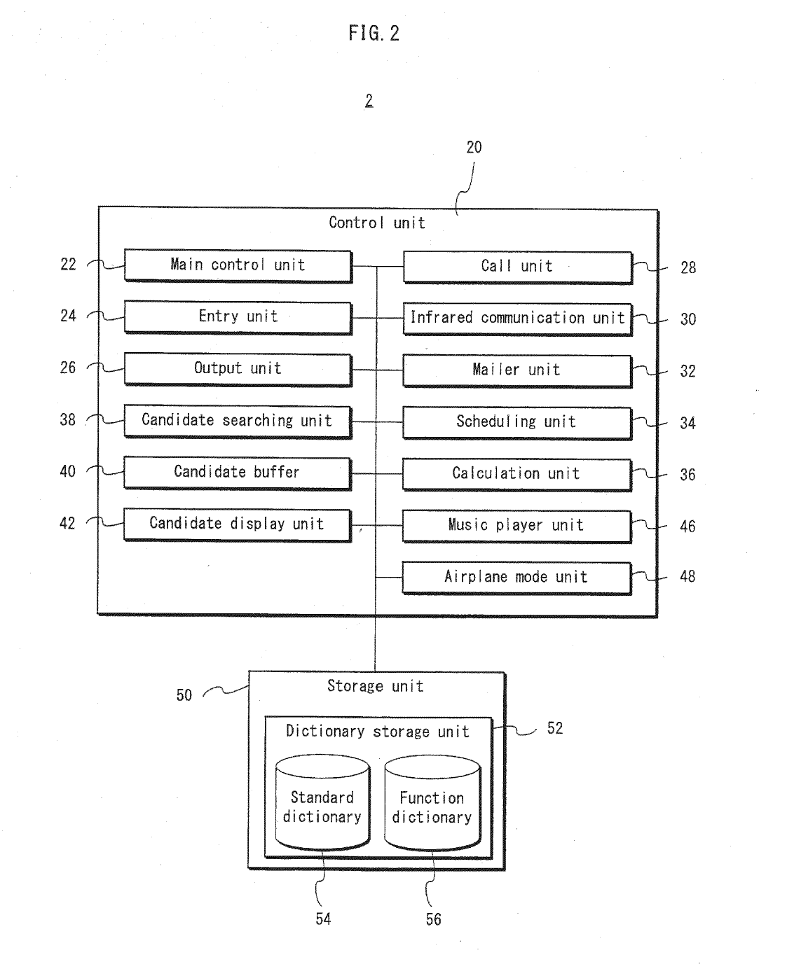

FIG. 2 is a functional block of the mobile phone 2. The mobile phone 2 includes a control unit 20 and a storage unit 50.

The control unit 20 includes a main control unit 22, an entry unit 24, an output unit 26, a call unit 28, an infrared communication unit 30, a mailer unit 32, a scheduling unit 34, a calculation unit 36, a candidate searching unit 38, a candidate buffer 40, a candidate display unit 42, a music player unit 46, and an airplane mode unit 48.

The main control unit 22 includes a control program. The main control unit 22 performs processing in accordance with an operation received by the entry unit 24, and controls the output unit 26 to output a result of the processing.

The entry unit 24 receives entry of an operation key (such as the dial key group 4, the call key 6, and the cursor key group 8).

The output unit 26 displays the result of the processing on the display 12, in accordance with a display instruction issued by the main control unit 22 or the candidate display unit 42.

The call unit 28 includes a communication circuit that is generally mounted on a mobile phone, and realizes a call function.

The infrared communication unit 30 sends and receives data to and from other mobile phone having an infrared communication function. The infrared communication unit 30 is in either two types of a Send mode and a Receive mode.

When the user of the mobile phone 2 hopes to execute the infrared communication function, the infrared communication unit 30 performs display via the output unit 26 for causing the user to face an infrared port of the mobile phone 2 to an infrared port of a mobile phone of a party. Although being convenient, this infrared communication function is infrequently used in general.

The mailer unit 32 is a mailer for creating, sending, and receiving mails.

The scheduling unit 34 realizes the scheduling function.

The calculation unit 36 performs calculations such as four arithmetic operations

The candidate searching unit 38 searches, based on a letter identified by entry of a key received by the entry unit 24, a dictionary storage unit 52 for a candidate relating to the letter.

Specifically, the candidate searching unit 38 searches for the following: (1) a word or a function name whose reading completely matches reading of the letter; (2) a word or a function name whose reading forward-matches the reading of the letter; and (3) a word that is associated with the reading of the letter (such as a synonym) or a function name that is associated with the reading of the letter. It is possible to employ a known art called “prediction conversion function” for searching for the above (2) and a known art called “association conversion function” for searching for the above (3).

The candidate buffer 40 includes a RAM and so on, and temporarily stores therein a word and a function name searched for by the candidate searching unit 38.

The candidate display unit 42 displays, via the output unit 26, a word, a function name, and so on stored in the candidate buffer 40.

The music player unit 46, for example, plays back music files stored in the mobile phone 2.

The airplane mode unit 48 switches the mode of the mobile phone 2 between a mode in which electric waves of the mobile phone 2 are transmitted and received (normal mode) and a mode in which electric waves of the mobile phone 2 are not transmitted and received (airplane mode). The airplane mode is for use of the mobile phone 2 inside an airplane.

The storage unit 50 includes a dictionary storage unit 52 that contains a standard dictionary 54 and a function dictionary 56.

The standard dictionary 54 is a known dictionary for converting an entered letter into a word based on reading of the letter, for example. The standard dictionary 54 has the data structure in which reading of a letter corresponds to a word.

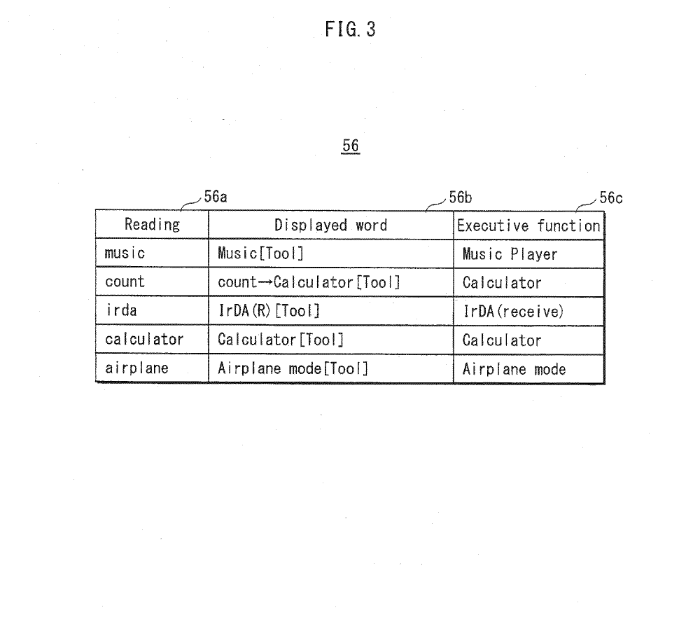

The function dictionary 56 has the data structure in which (1) reading of a function name, (2) a displayed word that is displayed as a candidate, and (3) an executive function that are in correspondence with one another. The function dictionary 56 is further described with reference to FIG. 3.

FIG. 3 shows an example of a data structure of the function dictionary 56.

The function dictionary 56 includes items a “reading” 56a, a “displayed word” 56b, and an “executive function” 56c.

The item “reading” 56a represents how to read a function name of each function. For example, an infrared receiving function “IrDA(R)” is read as “irda”.

Although reading “count” differs in spelling from a calculator function (“calculator”), the reading “count” is easily associated with the calculator function and accordingly is determined as reading that corresponds to the calculator function.

The “displayed word” 56b is an item for representing a word to be displayed as a candidate. The displayed word is composed of a combination of a function name of a function and a word “Tool” indicated by an angled-bracket. An angle-bracket is placed at the end of a field of the item so as to be easily distinguishable from a candidate word composed of a sequence of letters. Instead of the angled-bracket, a sign representing a function may be also employed.

The “executive function” 56c is an item representing a function that is started up (executed) in response to selection of a word listed in the “displayed word” 56b. For convenience sake, the table shown in FIG. 3 just includes a function name of each function. Actually, a function name is associated with a startup command of each function. The startup command for example includes designation of a storage location of an executable file of each function control program.

### <Operations>

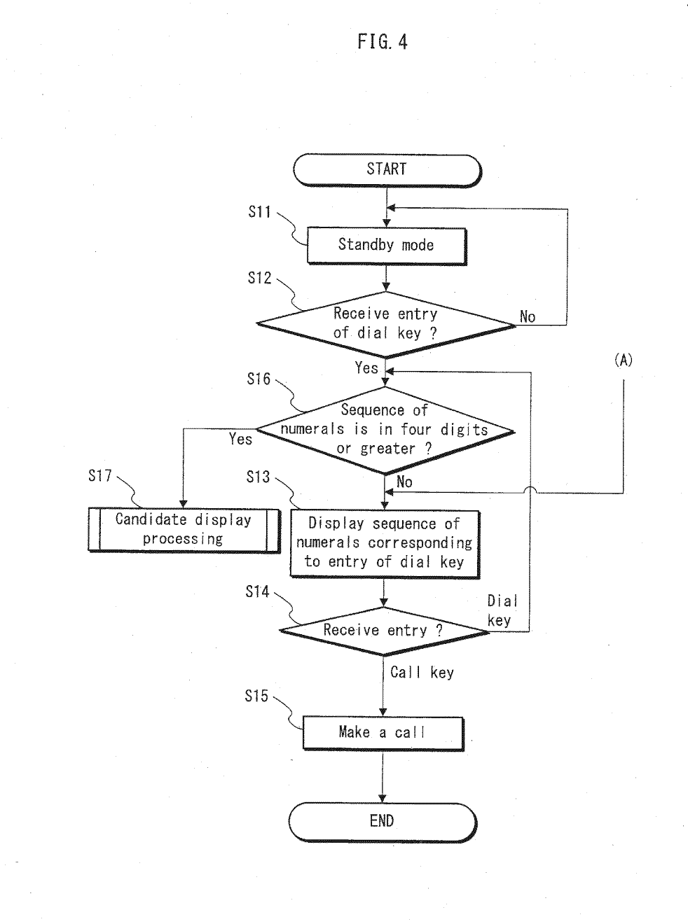

The following describes operations of the mobile phone 2 relating to the present embodiment with reference to FIG. 4 to FIG. 6.

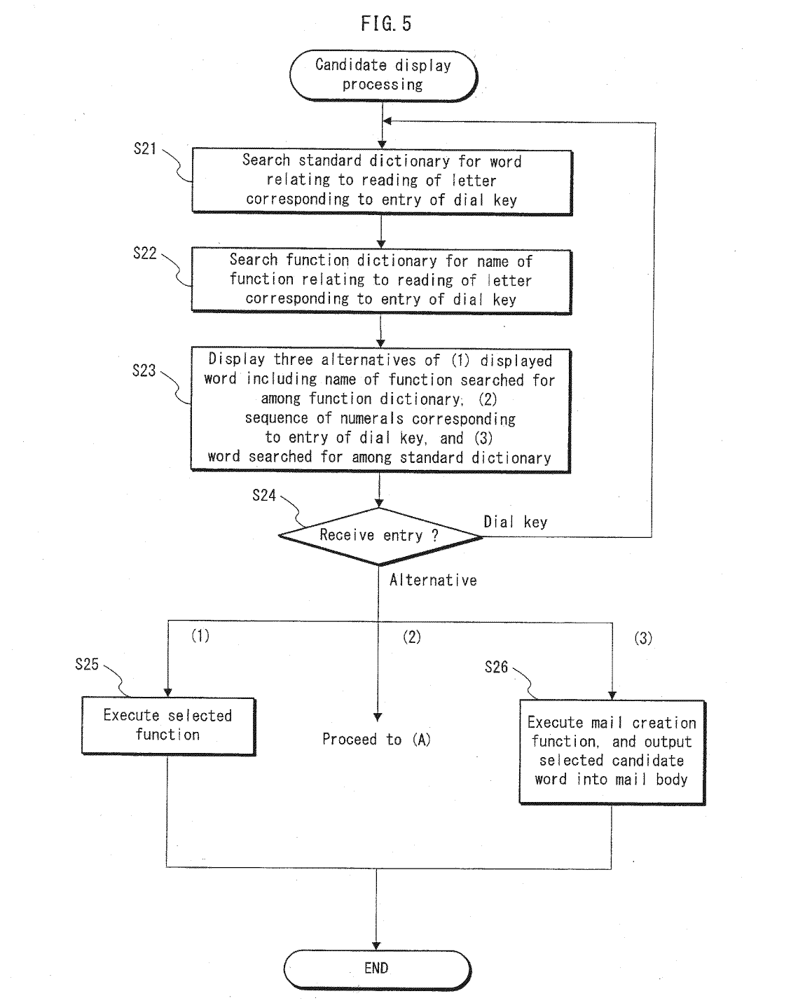

FIG. 4 and FIG. 5 are each a flow chart showing operations-of the mobile phone 2.

As shown in FIG. 4, when the entry unit 24 receives entry of the dial key group 4 in a standby mode (S11 and S12: Yes), the main control unit 22 controls, via the output unit 26, the display 12 to display a numeral corresponding to the received entry of the dial key group 4 (S13).

When the entry unit 24 receives entry of the call key 6 (S14: call key), the main control unit 22 performs control so as to make a call to a number represented by the numeral displayed in Step S13 via the call unit 28 (S15).

When the entry unit 24 further receives entry of the dial key group 4 (S14: dial key), the main control unit 22 controls the display 12 to display two numerals corresponding to the received entry of the dial key group 4.

When the number of digits of the numerals that are displayed reaches 4 as a 9 result of repetitive performance of the processing in Step S14: dial key and the display processing in Step S13 (S16: Yes), the processing flow proceeds to candidate display processing (S17).

In the candidate display processing as shown in FIG. 5, the main control unit 22 identifies a letter corresponding to entry of the dial key group 4, and the candidate searching unit 38 searches the standard dictionary 54 for a word relating to reading of the identified letter (S21). A result of the searching is stored in the candidate buffer 40.

The reading of the letter is identified based on the entry order of the dial key group 4.

For example, when the “4GHI” key is entered three times in succession, a letter being displayed is switched among letters “g”, “h”, and “i” in this order. As a result, the displayed letter is read as “i”.

Also, when the “3DEF” key, the “2ABC” key, the “8TUV” key, and the “2ABC” key are entered in this order, a letter being displayed is switched among letters “d”, “da”, “dat”, and “data” in this order. As a result, the displayed letter is read as “data”.

Also, when the “3DEF” key, the “3DEF” key, the “4GHI” key, the right key 8R included in the cursor key group 8, and the “4GHI ” key are entered in this order, a letter being displayed is switched among letters “d”, “e”, “eg”, and “egg” in this order. As a result, the displayed letter is read as “egg”.

Also, the candidate searching unit 38 searches the function dictionary 56 for a function name of a function relating to reading of a letter corresponding to entry of the dial key group 4 (S22). Note that the processing of Steps S21 and S22 may be simultaneously performed. Alternatively, the processing of Steps S21 and 22 may be performed in the reverse order.

Next, the candidate display unit 42 refers to the candidate buffer 40 to display the following three types of alternatives: (1) a function name of a function relating to the reading of the letter corresponding to the entry of the dial key group 4 (search result in Step S22); (2) a numeral corresponding to the entry of the dial key group 4; and (3) a word relating to the reading of the letter corresponding to the entry of the dial key group 4 (search result in Step S21) (S23).

Selection of the displayed alternative is received by the user shifting the upper key 8U and the lower key 8D included in the cursor key group 8. Determination of the selected alternative is performed by the user pressing the center key 10.

When the number of searching results of the above alternatives of function names (1) and words (3) are each plural, a plurality of function names and words may be displayed for each type of alternatives.

When the entry unit 24 receives selection of the alternative (1) (S24: (1)), the main control unit 22 executes a function corresponding to the displayed word selected with reference to the item “executive function” 56c of the function dictionary 56 (S25). In other words, by selecting the alternative (1), the user of the mobile phone 2 can easily start up the function corresponding to the alternative (1).

When the entry unit 24 receives selection of the alternative (2) (S24: (2)), the processing flow returns to Step S13. The main control unit 22 performs control so as to display a numeral corresponding to entry of the dial key group 4 (S13). Here, when selecting the alternative (2), the user of the mobile phone 2 can return to the original screen state where the numeral corresponding to the entry of the dial key group 4 is displayed.

When the entry unit 24 receives selection of the alternative (3) (S24: (3)), the main control unit 22 starts up the mail creation function of the mailer unit 32 to call a mail creation screen for newly creating a mail. Then, in a mail body of the mail (composed of destination, title, and text), the selected candidate word is entered (S26). The cursor is positioned behind a word that has been lastly entered. In this way, when hoping to create a mail using the mobile phone 2, the user enters a key corresponding to a letter the user hopes to enter in a mail body of the mail, and selects the alternative (3) using the cursor key group 8 and the center key 10. As a result, the user can create the mail without additionally starting up the mail creation function.

Then, when the entry unit 24 receives entry of the dial key (S24: dial key), the processing flow returns to Step S21.

The following-describes an example of specific operations with reference to FIG. 6 from the view point of the user interface.

FIG. 6A to FIG. 6G show the switching screens 80a to 80g on the display, respectively.

When entry of the “4GHI” key is received on the screen 80a in the standby mode three times in succession, the main control unit 22 switches from the screen 80a to the screen 80b on which numerals “444” corresponding to the entry are displayed.

Next, when entry of a “7PQRS” key is received once, the main control unit 22 identifies reading as “ip” because of the entry of the successive three-time entry of the “4GHI” key and the one-time entry of the “7PQRS” key and switching of reading of the letter among the letters “g”, “h”, “i”, and “ip” in this order.

Then, the main control unit 22 switches from the screen 80b to the screen 80c on which the reading “jp” of the letter and three alternatives 81 to 83 each relating to the “jp” are displayed.

Furthermore, when entry of the “7PQRS” key is received twice in succession, the main control unit 22 switches the reading of the letter being displayed among letters of “ip”, “iq”, and “ir” in this order, and switches the screen 80c to the screen 80d on which the reading “ir” and three alternatives 84 to 87 each relating to the “ir” are displayed.

When selection of an alternative “IrDA(R)[Tool]” 84 is received on the screen 80d, the main control unit 22 controls the infrared communication unit 20 to execute the infrared receiving function to switch the screen 80d to the screen 80e on which the infrared receiving function is displayed.

When selection of an alternative “444777[TEL]” 85 is received, the main control unit 22 switches from the screen 80e to the original screen 80f on which the numerals corresponding to the entry are displayed.

An alternative “iron” 86 is an alternative representing conversion that forward-matches “ir”. When selection of the alternative “iron” 86 is received, the main control unit 22 switches from the screen 80f to the screen 80g on which the mail creation function is displayed. On the screen 80g, the word “iron” is entered in the mail body of the mail, and the user can continue to create the mail from the cursor position on the end of the mail body. The same applies to the alternative “Irvine” 87.

According to the mobile phone 2 relating to the present embodiment as described with reference to FIG. 6, when the user hopes to execute the infrared receiving function (IrDA(R)), the user can start up the infrared receiving function only by selecting the alternative “IrDA(R)[Tool]” 84 that is displayed in response to the entry of the reading “ir”.

According to conventional methods, in order to start up the infrared receiving function, the user needs to trace items “Menu”, “Tools”, “Infrared”, and “Infrared receiving” in this order many times, for example. Also, if the user does not originally memorize the hierarchical structure, the user has difficulty searching the menu for his desired function.

Compared with this, according to the present embodiment, the user can search for the infrared receiving function using the reading “IrDA” of the function as a clue. Accordingly, even if the user memorizes only the reading “IrDA” and does not memorize the menu structure, the user can search for the infrared receiving function in one way or another.

A numeral corresponding to key entry is always displayed on each of the screens 80b, 80c, 80d, and 80f such that the user can make a call at any time. Accordingly, the user can make a cll to a phone number that the user has entered, with no difficulty.

Furthermore, when the user hopes to execute the mail creation function, the user can smoothly create a mail by only entering the “4GHI” key three times in succession, entering the “7PQRS” key three times in succession, and then selecting the alternative “iron” 86, as shown in the switching among the screens 80b, 80c, 80d, and 80g. In other words, without taking the time to call the mail creation function, the user can start up the mail creation function in the standby mode by entering the key as if the user performed letter entry as usual, thereby to continue to create the mail.

Note that when selection of an alternative “4447[Tel]” 81 is received on the screen 80c, the main control unit 22 switches from the screen 80c to a screen on which a numeral corresponding to the entry is displayed such as the screen 80f Also, when selection of an alternative “ip” 82 or an alternative “ips” 83 is received on the screen 80c, the main control unit 22 switches from the screen 80c to a screen on which a word corresponding to the selected alternative is entered in the mail body of the mail such as the screen 80g.

### Embodiment 2

According to the structure of the Embodiment 1, it is intended that a function is easily executed using a function name of the function. Compared with this, according to the structure of the Embodiment 2, it is intended that address settings are easily performed using a name of a communication party included in an address book.

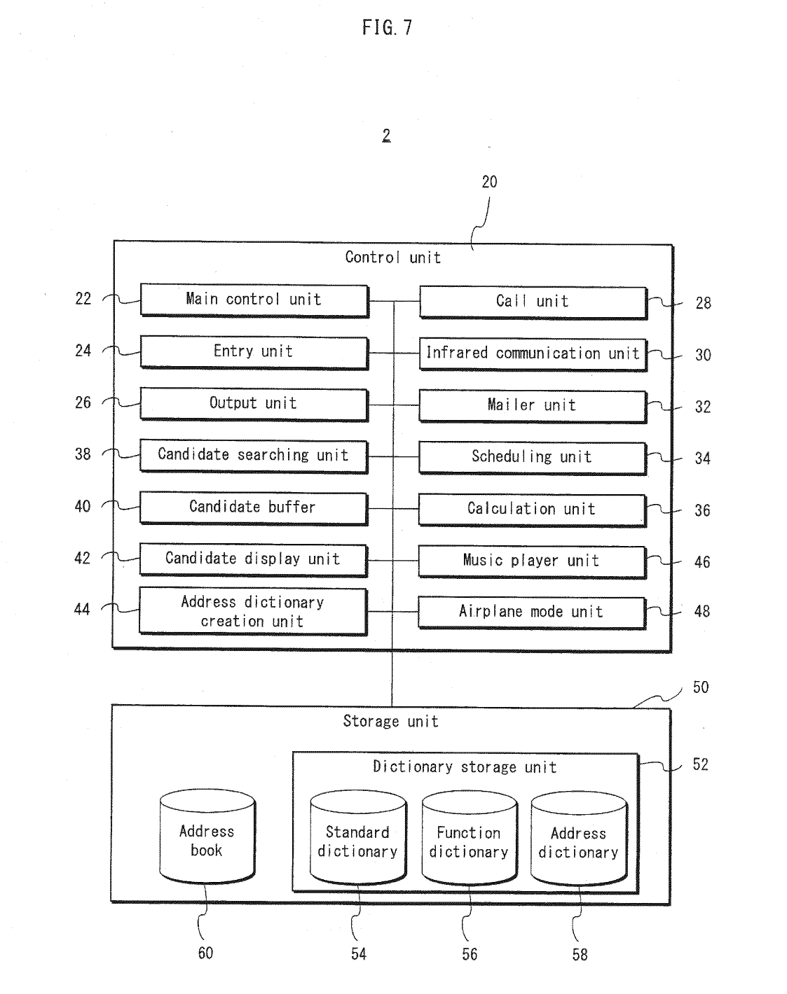

FIG. 7 is a functional block of a mobile phone 2 relating to the Embodiment 2. Functional blocks shown in FIG. 7 that are the same as those shown in FIG. 2 have the same referential numerals, and accordingly descriptions thereof are omitted here.

The control unit 20 includes an address dictionary creation unit 44. A storage unit 50 includes an address dictionary 58 and an address book 60.

The address book 60 has the data structure in which addresses, which includes phone numbers and mail addresses, names of communication parties corresponding to the addresses, and readings of the names are described in list form.

The address dictionary 58 is a dictionary created based on the address book 60 by the address dictionary creation unit 44.

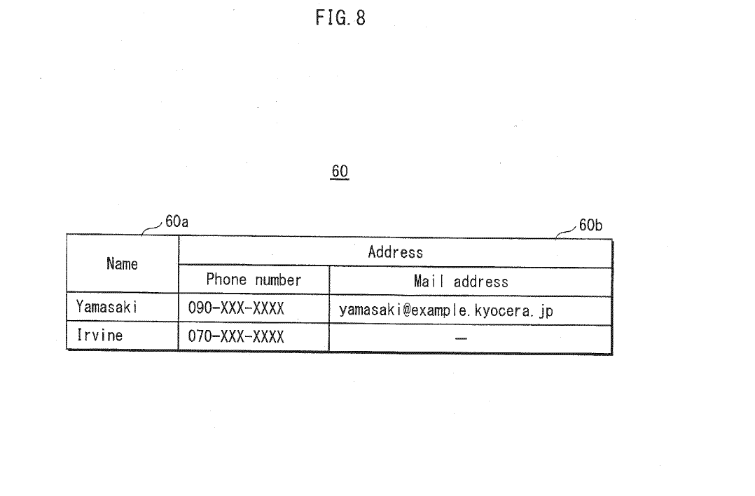

FIG. 8 shows an example of the data structure of the address book 60.

The address book 60 includes an item “name” 60a and an item “address” 60b.

A name listed in the “name” 60a corresponds to an address listed in the “address” 60b.

The “address” 60b includes an item “phone” and an item “mail”.

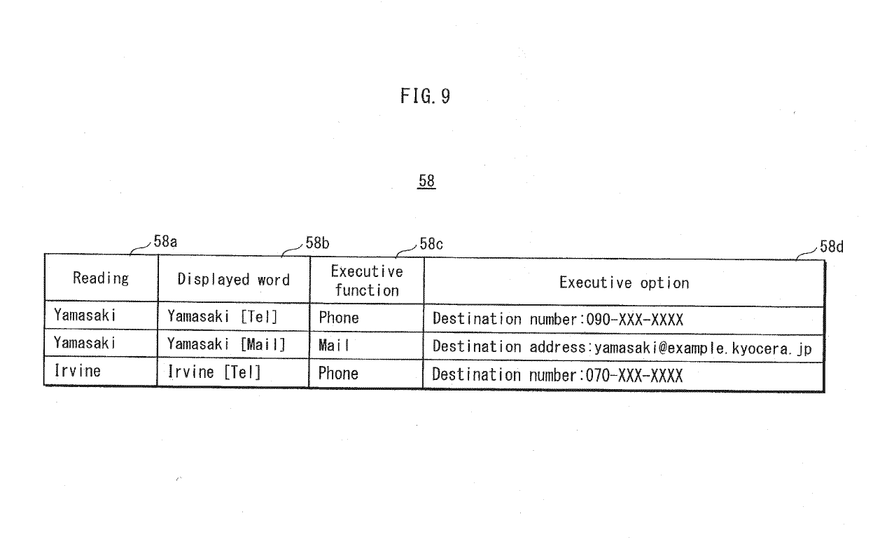

FIG. 9 shows an example of the data structure of the address dictionary 58.

The address dictionary 58 includes items “reading” 58a, “displayed word” 58b, “executive function” 58c, and “executive option” 58d.

In the item “displayed word” 58b, each term [Tel] and [Mail] indicated by an angled-bracket in the end of the item represents a function corresponding thereto.

The item “executive option” 58d’ relates to an additional condition of a function to be executed. When a function to be executed is the call function, the additional condition is a destination phone number. When the function to be executed is the mail function, the additional condition is a destination mail address.

### <Operations>

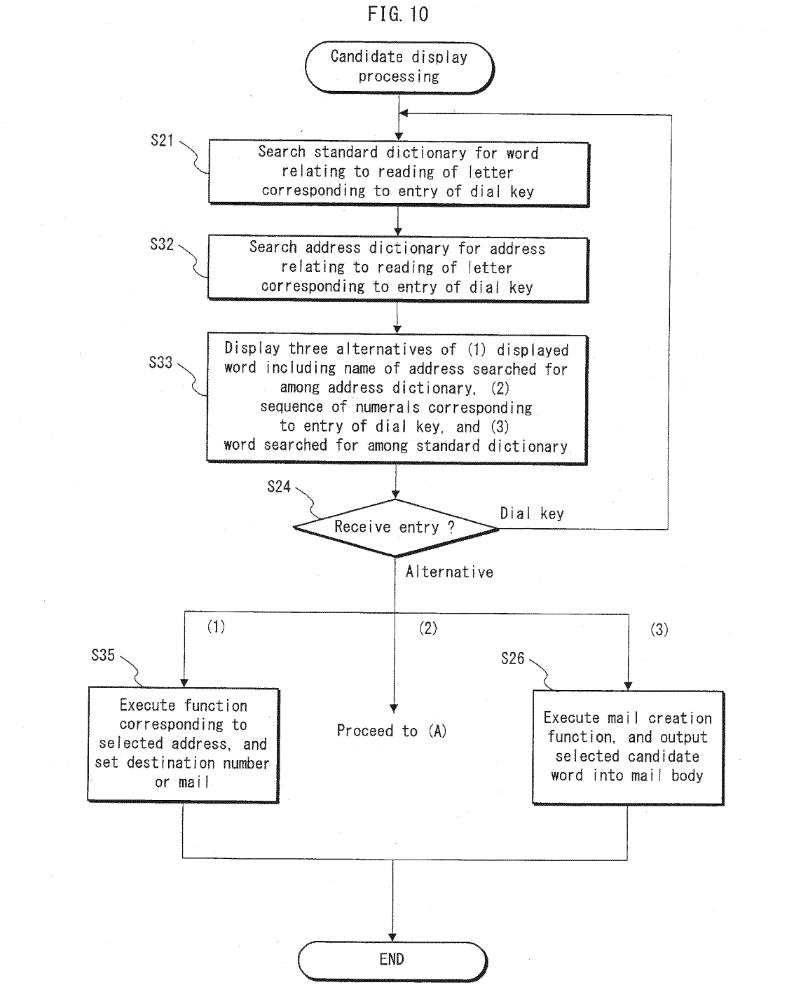

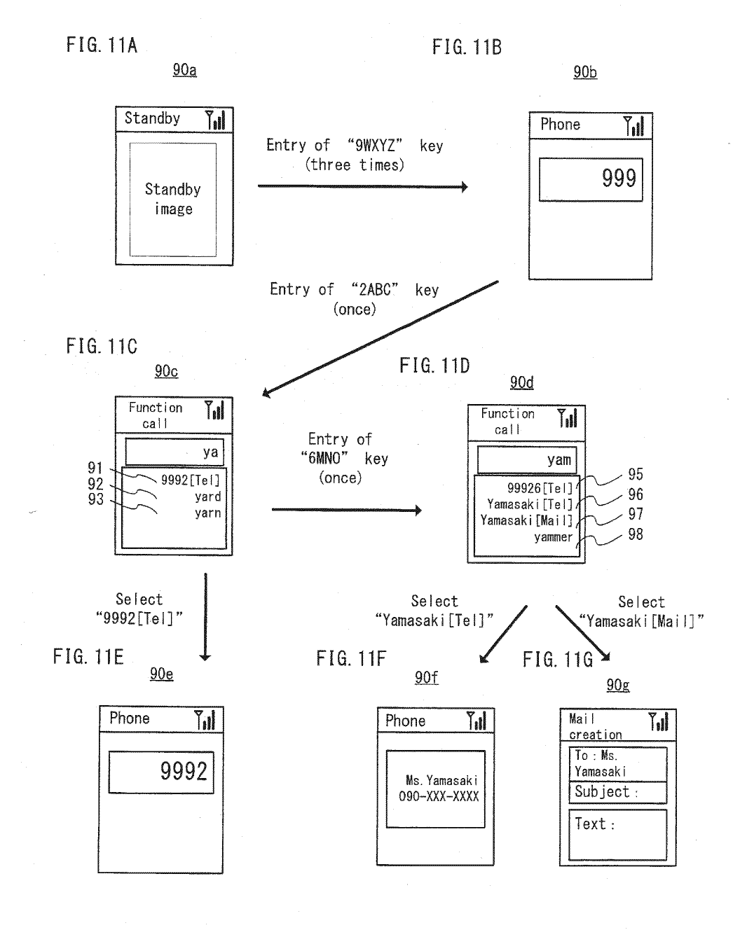

The following describes operations of the mobile phone 2 relating to the present embodiment with reference to FIG. 10 to FIG. 11.

FIG. 10 is a flow chart showing the operations of the mobile phone 2.

The former part of the operations relating to the standby mode is the same as the FIG. 4, and accordingly descriptions thereof are omitted here. Also, processing shown in FIG. 10 that is the same as that shown in FIG. 5 is described briefly with use of Step numbers that are the same as those shown in FIG. 5.

In the candidate display processing as shown in FIG. 10, the main control unit 22 identifies a letter corresponding to entry of the dial key group 4. Then, the candidate searching unit 38 searches the standard dictionary 54 for a word relating to reading of the identified letter (S21).

Also, the candidate searching unit 38 searches the address dictionary 58 for an address of a name relating to reading of the letter corresponding to the entry of the dial key (S32).

Next, the candidate display unit 42 displays three types of alternatives including (1) a displayed word including the name of the address searched for, (2) a numeral corresponding to the entry of the dial key, and (3) the word searched for (S33).

When the entry unit 24 receives selection of the alternative (1) (S34: alternative (1)), the main control unit 22 executes a function corresponding to the address searched for (S35). When the corresponding function is the call function, a destination phone number is set. When the corresponding function is the mail function, a destination mail address is set.

When the entry unit 24 receives selection of the alternative (2) (S34: alternative (2>>), the flow returns to Step S13. The main control unit 22 performs control to display a numeral corresponding to the entry of the dial key (S13).

When the entry unit 24 receives selection of the alternative (3) (S34: alternative (3)), the main control unit 22 executes the mail creation function of the mailer unit 32 to enter a word selected as a candidate in the mail body of the mail (S26).

The following describes an example of specific operations with reference to FIG. 11 from the view point of the user interface.

FIG. 11A to FIG. 11G show switching screens 90a to 90g on the display, respectively.

When entry of the “9WXYZ” key is received on the screen 90a in the standby mode three times in succession, the main control unit 22 switches from the screen 90a to the screen 90b on which numerals “999” corresponding to the entry are displayed.

Then, entry of the “2ABC” key is received once. As a result, the three-time entry of the “9WXYZ” key and the one-time entry of the “2ABC” key are received so far. Accordingly, the main control unit 22 identifies reading of the letter as “ya” by switching among the readings “w”, “x”, “y”, and “ya” in this order.

Then, the main control unit 22 switches from the screen 90b to the screen 90c on which the following are displayed: an alternative “9992[Tel]” 91 representing numerals corresponding to successive three-time entry of the “9WXYZ” key and one-time entry of the “2ABC” key, and alternatives “yard” 92 and “yarn” 93 that are each a conversion candidate that forward-matches the reading “ya” of the letters.

When selection of the alternative “9992[Tel]” 91 is received on the screen 90c, the main control unit 22 returns the screen 90c to the screen 90e in the original phone mode. When selection of the alternatives “yard” 92 or “yarn” 93 is received, the main control unit 22 switches from the screen 80c to a screen on which the mail creation function is displayed, and a word corresponding to the selected alternative is entered in the mail body of the mail (not shown), in the same way as the screen 80g (FIG. 6).

When entry of the “6MNO” key is received without receiving selection of the alternatives 91 to 93, the main control unit 22 identifies the reading of the letter as “yam” based on the successive three-time entry of the “9WXYZ” key, the one-time entry of the “2ABC” key, and the one-time entry of the “6MNO” key.

Then, the main control unit 22 displays, on the screen 90d, four alternatives including an alternative “99926[Tel]” 95 corresponding to the sequence of numerals, alternatives “Yamasaki[Tel]” 96, “Yamasaki[Mail]” 97, and “yammer” 98 that each forward-match the reading of the letter “yam”.

When selection of the alternative “Yamasaki[Tel]” 96 is received, the main control unit 22 returns the screen 90d to the original screen in the phone mode, and further switches from the original screen to the screen 90f on which a phone number “090-XXX-XXXX” of “Yamasaki”, which is registered in the address book 60, are displayed.

When selection of the alternative “Yamasaki[Mail]” 97 is received, the main control unit 22 switches from the screen 90d to the screen 90g on which the mail creation function is displayed, and a mail address of “Yamasaki” (yamasaki@example.kyocera.jp), which is registered in the address book 60, is set as the destination mail address.

As described with reference to FIG. 11, according to the mobile phone 2 relating to the present embodiment, the user who hopes to make a call or a send a mail to “Yamasaki”, who is registered in the address book of the mobile phone 2, the user can search for “Yamasaki”'s phone number or mail address using the reading “Yamasaki” of the letter “Yamasaki” as a clue.

Also, the user can search for a desired phone number or mail address by performing key entry in the standby mode without additionally calling the address book. This improves user convenience. Furthermore, when the user hopes to make a call to a phone number beginning with numerals “9992” , the user can make a call to the phone number by selecting an alternative “9992[Tel]” 91 on the screen 90c.

### <Supplementary Explanations>

Although the embodiments of the present invention have been described, the present invention is not limited to the above embodiments. The present invention can be implemented in various embodiments for achieving the aim of the present invention and an aim relating to the aim of the present invention. For example, the following may be employed.

1. According to the Embodiment 1, when the number of digits of a sequence of numerals reaches 4, the processing flow proceeds to the candidate display processing (FIG. 4: S16). This is because the sequence of numerals in three digits has a possibility of being a phone number for emergency contact.

Without limiting to this, the condition for proceeding to the candidate display processing can be appropriately set in consideration of a possibility of making a call to a phone number represented by a sequence of numerals.

For example, with respect to entry of reading of letters “Aggie”, it is considered that keys are entered in the following order of the “2ABC.” key, the “4GHI” key, the right key 8R, the “4GID” key, the right key 8R, the “4GHI” key, the “4GHI” key, the “4GHI” key, the “3DEF” key, and the “3DEF” key. The right key 8R has a low possibility of being used for entering a numeral to make a call. Accordingly, when entry of the right key 8R is detected, the processing flow may proceed to the candidate display processing.

Alternatively, when entry of either of the upper key 8U, the lower key 8D, the left key 8L, and the right key 8R included in the cursor key group 8 is detected, the processing flow may proceed to the candidate display processing.

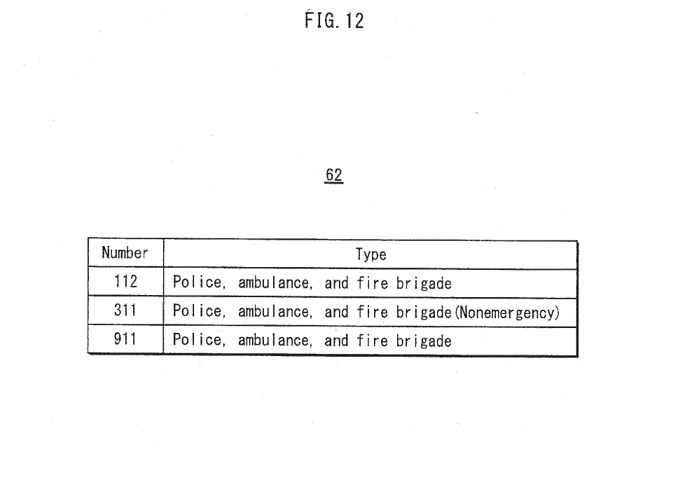

Further alternatively, the following case may be employed. As shown in FIG. 12 for example, the storage unit 50 stores therein a number table 62 including phone numbers for emergency contact such as “112”, “312 ” , and “911 ”. Then, when a sequence of numerals such as “223 ” corresponding to entry of keys does not coincide with the sequences of numerals included in the number table 62, it is considered that the sequence of numerals has a low possibility of being used for making a call, and accordingly the processing flow immediately proceeds to the candidate display processing. Further alternatively, the following may be also employed on the contrary. When a sequence of numerals that matches (forward-matches) a phone number for emergency contact, it is considered that the sequence of numerals has a high possibility of being used for making a call. Accordingly, by preventing display of an alternative representing a function, a phone number for emergency contact is entered with no difficulty.

2. According to the Embodiment 1, when the number of digits of a sequence of numerals reaches 4, the processing flow proceeds to the candidate display processing (FIG. 4: S16). Without limiting to this, when an entered numeral is in a single digit, the processing flow may immediately proceed to the candidate display processing.

3. According to the Embodiment 1, as shown on the screen 60d shown in FIG. 6, the IrDA(R)[Tool] representing the infrared receiving function includes the function name “IrDA”. Alternatively, a function name of each function does not necessarily need to be included.

In other words, an alternative representing each function may be displayed such that the user understands what function is represented by the displayed alternative. Accordingly, a pictograph representing the function may be displayed as the alternative. For example, a pictograph of a musical note may be employed as an alternative representing a music function, and a pictograph of a mail may be employed as an alternative representing the mail function.

4. According to the Embodiment 1, as shown on the screens 80d and 80g shown in FIG. 6, when selection of the alternative “iron” 86 is received, the mail function is executed. Without limiting to the mail function, it may be possible to execute another function having a function for editing a text such as the scheduling function and a memo pad function.

5. Although special explanation has not been provided in the Embodiments 1 and 2, it is preferable that the user can set and change the condition for proceeding to the candidate display processing, such as whether to proceed to the candidate display processing and whether to display an alternative representing a function.

6. According to the Embodiments 1 and 2, the description has been provided with use of the example of a mobile phone having the structure in which alphabets are assigned to the keys included in the dial key group 4. However, the present invention is not limited to this.

For example, it may be possible to apply the Embodiments 1 and 2 to a mobile phone having a structure in which Hangul letters or Japanese Hiragana letters are assigned to dial keys.

7. The Embodiments 1 and 2 may be implemented by combining with each other. For example, it may be possible to search the address dictionary 58 for an address “Irvine” that forward-matches reading “ir” of an entered letter on the screen 80d shown in FIG. 6, and display the address “Irvine” as an alternative.

8. According to the Embodiments 1 and 2, the descriptions have been provided with use of the example of a method of identifying a letter by entering the same key several times in succession. For example, a letter “y” is identified by entering the “9WXYZ” key three times in succession. Alternatively, a method called “T9 mode” may be employed as a method of performing letter entry.

According to the T9 mode, a consonant is assigned to each key, and a word is predicted based on a consonant entered by a key. This mode can realize simple entry of letters with few number of pressing keys.

9. According to the Embodiments 1 and 2, an alternative is selected using the cursor key 8, and then the selected alternative is determined using the center key 10. Alternatively, an alternative may be selected using a specific key included in the mobile phone 2.

For example, the “Yamasaki[Tel]” 96 and the “Yamasaki[Mail]” 97 are displayed as alternatives on the screen 90d shown in FIG. 11. When entry of the call key 6 is received in this state, a call to the phone number of “Yamasaki” may be immediately made. Alternatively, when entry of a mail button (not shown), which is generally included in a mobile phone, is received, the screen may be directly switched to a screen for creating a mail to a mail address of “Yamasaki”.

In this way, by making it possible to select an alternative using a key that is used for calling a function such as the call function and the mail function, the user can operate the mobile phone with a better intuitive feeling.

10. According to the Embodiments 1 and 2, the description has been provided using the example in which entry is received via the keys 4, 6, 8, and 10 physically provided in the mobile phone 2. Alternatively, it may be possible to apply the Embodiments 1 and 2 to a mobile phone including a virtual keyboard in which a shape of a keyboard is displayed on a screen for receiving entry.

11. According to the Embodiments 1 and 2, as shown ill FIG. 6, the description has been provided using the example in which the user is caused to select an alternative representing a desired function among alternatives. Alternatively, it may be possible to employ the structure in which only one alternative is displayed and the user is caused to decide whether to select the alternative by selecting options “YES” or “NO”. Further alternatively, it may be possible to employ the structure in which a certain function is automatically selected and started up.

### <Summary>

The mobile phone relating to the present embodiments may have the following structure.

1. A mobile phone that includes keys to which numerals and letters are assigned, and when receiving key entry of any of the keys in a standby mode, displays a numeral corresponding to the key entry, the mobile phone comprising: a control unit operable, when a predetermined condition is satisfied by a sequence of numerals corresponding to key entry received in the standby mode, to display a function name including one or more letters corresponding to the key entry; and a startup unit operable to start up a function indicated by the displayed function name.

2. A mobile phone that includes keys to which numerals and letters are assigned, and when receiving key entry of any of the keys in a standby mode, displays a numeral corresponding to the key entry, the mobile phone comprising: a function searching unit operable, when judging that a predetermined condition is satisfied by a sequence of numerals corresponding to key entry received in the standby mode, to search for a function whose function name includes one or more letters corresponding to the key entry; an alternative display unit operable to display an alternative indicating the function searched for by the function searching unit; and a startup unit operable, when selection of the alternative displayed by the alternative display unit is received, to start up the function indicated by the alternative.

With this structure, a desired function is searched for using one or more letters corresponding to key entry, and a function name of the function searched for is displayed as an alternative. As a result, by selecting this alternative, the user can easily start up the function corresponding to the selected alternative.

3. When the number of digits of the sequence of numerals corresponding to the key entry reaches a predetermined value, the function searching unit may judge that the predetermined condition is satisfied.

With this structure, it is possible to appropriately set a trigger for the function searching unit, using the number of digits of a sequence of numerals.

4. When the predetermined condition is judged to be satisfied, the alternative display unit may display a list of an alternative indicating the sequence of numerals corresponding to the key entry and the alternative indicating the function, and when selection of the alternative indicating the sequence of numerals is received, the alternative display unit may stop displaying the alternative indicating the function.

With this structure, by stopping display of the alternative of the function, it is possible to realize an interface friendly for a user who hopes to make a call to a phone number represented by the displayed sequence of numerals, for example.

5. The alternative indicating the sequence of numerals may be displayed in a form of the sequence of numerals and an identification mark indicating that the sequence of numerals represents a phone number.

With this structure, by displaying the identification mark, it is possible to notify the user that a displayed sequence of numerals represents a phone number, for example.

6. When the predetermined condition is judged to be satisfied, the alternative display unit may display a list of an alternative indicating a conversion candidate for the one or more letters corresponding to the key entry and the alternative indicating the function.

7. When selection of the alternative indicating the conversion candidate for the one or more letters is received, the startup unit may start up a mail creation function, and output the conversion candidate indicated by the selected alternative into a display area in a mail body.

With this structure, it is possible to seamlessly shift from the standby screen to the mail creation screen.

8. The mobile phone may further comprise: an address dictionary storage unit operable to store therein an address dictionary in which names of communication parties correspond to phone numbers; and a searching unit operable, when the predetermined condition is judged to be satisfied, to search the address dictionary for a name relating to one or more letters corresponding to the key entry, wherein the alternative display unit displays a list of an alternative indicating making a call to a phone number corresponding to the name searched for and the alternative indicating the function, and when selection of the alternative indicating making a call to the corresponding phone number is received, the alternative display unit displays indication of making a call to a communication party having the name corresponding to the phone number.

With this structure, by switching from display of a phone number to display of a name corresponding to the phone number, it is possible to notify the user of a call destination party.

9. The phone number may further comprise: an address dictionary storage unit operable to store therein an address dictionary in which names of communication parties correspond to mail addresses; and a searching unit operable, when the predetermined condition is judged to be satisfied, to search the address dictionary for a name relating to one or more letters corresponding to the key entry, wherein the alternative display unit displays a list of an alternative indicating creating a mail to a mail address corresponding to the name searched for and the alternative indicating the function, and when selection of the alternative indicating creating a mail is received, the startup unit starts up a mail creation function, and sets the corresponding mail address as a destination mail address.

With this structure, it is possible to further facilitate setup of a mail sending destination in the standby mode, for example.

10. The mobile phone may further comprise: a table storage unit operable to store therein a phone number table that includes phone numbers; and a display control unit operable, when the sequence of numerals corresponding to the key entry matches any of the phone numbers included in the phone number table, to control the alternative display unit to stop displaying the alternative indicating the function.

With this structure, by stopping display of the alternative indicating the function to prioritize display of a phone number, it is possible to make a call to the displayed phone number more smoothly.

11. A mobile phone that includes keys to which numerals and letters are assigned, and when receiving key entry of any of the keys in a standby mode, displays a numeral corresponding to the key entry, the mobile phone comprising: a function searching unit operable to search for a function whose function name includes one or more letters based on key entry received in the standby mode; an alternative display unit operable to display an alternative indicating the function searched for by the function searching unit; and a startup unit operable, when selection of the alternative indicating the function is received, to start up the function indicated by the alternative.

### INDUSTRIAL APPLICABILITY

The mobile phone relating to the present invention contributes to the improvement of a user interface.

### REFERENCE SIGNS LIST

2: mobile phone
4: dial key
8: cursor key
8R: right key
12: display
22: main control unit
24: entry unit
26: output unit (display output unit)
28: call unit
32: mailer unit
38: candidate searching unit
42: candidate display unit
44: address dictionary creation unit
56: function dictionary
58: address dictionary
60: address book
80a-80g and 90a-90g: screen
81-87 and 91-96: alternative

1. A mobile phone comprising:
a plurality of keys, wherein each of the plurality of keys is assigned to at least one letter;
a display; and
a controller configured to:
detect an entry of at least one of the plurality of keys;
search for a function whose function name includes one or more letters corresponding to the at least one of the plurality of keys in response to receiving the entry; and
cause the display to display both of the one or more letters corresponding to the at least one of the plurality of keys and an icon indicating the function.

2. The mobile phone according to claim 1, wherein the controller configures to start up the function in response to a selection of the icon by user.

3. The mobile phone according to claim 1, wherein the controller configures to search for, among a dictionary, a word including the one or more letters corresponding to the at least one of the plurality of keys in response to receiving the entry and cause the display to display the word.

4. The mobile phone according to claim 1, wherein the controller configures to decide whether to cause the display to display the icon based on a condition set by a user.
